(19) United States
(12) Patent Application Publication
(10) Pub. No.: US 2025/0240723 A1
(43) Pub. Date: Jul. 24, 2025

(54) COMMUNICATION METHOD AND APPARATUS, AND COMMUNICATION DEVICE

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/848,079

(22) PCT Filed: Mar. 18, 2022
(86) PCT No.: PCT/CN2022/081844

§ 371 Date: Sep. 17, 2024

(51) Int. Cl. H04W 52/02; H04L 5/00; H04W 72/1263; H04W 76/28

(52) U.S. Cl. CPC H04W 52/0235; H04L 5/0005; H04W 72/1263; H04W 76/28

(57) ABSTRACT

A communication method is applicable to a terminal device in a connected state. The terminal device includes a first receiver and a second receiver. The method includes: receiving a wake-up signal via the first receiver; and waking up the second receiver in response to the wake-up signal. In the present disclosure, for the terminal device in the connected state, the second receiver is awakened after the wake-up signal is received via the first receiver, so as to wake up the UE in the connected state, thereby saving an energy consumption.

### CROSS-REFERENCE TO RELATED APPLICATION

This application is the U.S. national phase application of International Application No. PCT/CN2022/081844, filed on Mar. 18, 2022, the disclosure of which is incorporated herein by reference in its entirety for all purposes.

### TECHNICAL FIELD

The present disclosure relates to the field of wireless communication technologies, and in particular to a communication method, a communication apparatus and a communication device.

### BACKGROUND

A power saving project of the 3rd generation partnership project (3GPP) introduces a power saving signal, namely a wake-up signal (WUS). The WUS is a low power detection signal. When a terminal device detects the WUS, it means that the terminal device is expected to monitor a physical downlink control channel (PDCCH). However, if no WUS is detected, the terminal device skips monitoring the PDCCH.

At present, how to wake up the terminal device in a connected state (RRC-Connected) through the wake-up signal is an urgent problem to be solved.

### SUMMARY

The present disclosure provides a communication method, a communication apparatus and a communication device, so as to wake up a terminal device in a connected state through a wake-up signal.

According to a first aspect of the present disclosure, a communication method is provided, which is applicable to a terminal device in a connected state in a communication system. The terminal device includes a first receiver and a second receiver. The first receiver is an ultra-low power wake-up receiver and is dedicated to receiving a wake-up signal, and the second receiver is a main receiver and is configured to receive control information and/or transmission data. The method may include: receiving the wake-up signal via the first receiver: and waking up the second receiver in response to the wake-up signal.

According to a second aspect of the present disclosure, a communication device is provided, for example, a terminal device in a connected state. The communication device may include an antenna, a memory and a processor. Wherein the processor is connected respectively to the antenna and the memory, and is configured to execute computer-executable instructions stored on the memory to control transmission and reception of the antenna and to: receive a wake-up signal via the first receiver: and wake up the second receiver in response to the wake-up signal.

In the present disclosure, for a UE in a connected state according to the examples of the present disclosure, a second receiver is awakened after a wake-up signal is received via a first receiver, so as to wake up the UE in the connected state, thereby saving an energy consumption of the UE.

It is to be understood that the aspects of the present disclosure are consistent with the technical solutions of the first aspect of the present disclosure, and the beneficial effects achieved by each aspect and the corresponding feasible implementations are similar, which will not be repeated here.

### BRIEF DESCRIPTION OF THE DRAWINGS

In order to explain the technical solution in examples of the disclosure more clearly, the accompanying drawings that need to be used in the description of the examples will be briefly introduced below. The accompanying drawings in the following description are merely some examples of the disclosure, and for those of ordinary skill in the art, on the premise of no creative labor, other accompanying drawings can also be obtained according to these accompanying drawings.

FIG. 1 is a schematic structural diagram of a communication system in an example of the present disclosure.

FIG. 2 is a schematic structural diagram of a terminal device in an example of the present disclosure.

FIG. 3 is a schematic implementation flowchart of a first communication method in an example of the present disclosure.

FIG. 4 is a schematic diagram of periodically monitoring scheduling information by a UE in an example of the present disclosure.

FIGS. 5A and 5B are schematic diagrams of aperiodically monitoring by a UE in an example of the present disclosure.

FIG. 6 is a schematic structural diagram of a communication apparatus in an example of the present disclosure.

FIG. 7 is a schematic structural diagram of a communication device in an example of the present disclosure.

FIG. 8 is a schematic structural diagram of a terminal device in an example of the present disclosure.

### DETAILED DESCRIPTION OF THE EMBODIMENTS

Embodiments will be described in detail here with the examples thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the examples of the present disclosure are for the purpose of describing particular examples only, and are not intended to limit the examples of the present disclosure. Terms determined by “a” and “the” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, “first information” may be referred to as “second information”; and similarly, “second information” may also be referred to as “first information”. Depending on the context, the word “if” as used herein may be interpreted as “when”, “upon”, or “in response to determining”.

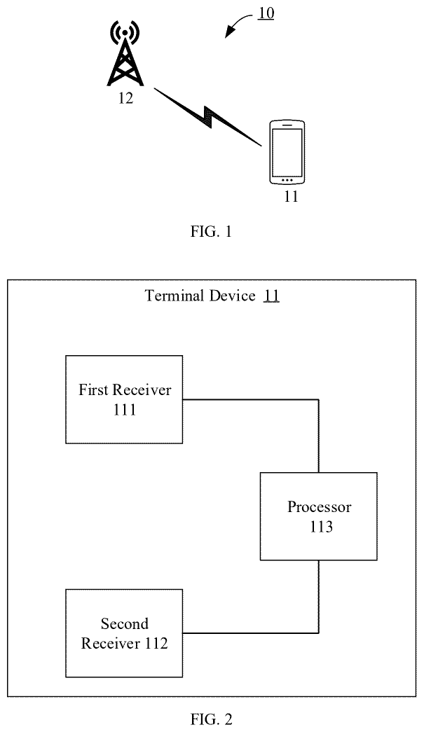

An example of the present disclosure provides a communication system. The communication system may be a communication system adopting cellular mobile communication technologies. FIG. 1 is a schematic structural diagram of a communication system in an example of the present disclosure. As illustrated in FIG. 1, the communication system 10 may include: at least one terminal device 11 and at least one network device 12.

In one example, the terminal device 11 may be a device that provides a voice or data connectivity to a user. In some examples, the terminal device may also be referred to as user equipment (UE), mobile station, subscriber unit, station or terminal equipment (TE), etc. The terminal device may be a cellular phone, a personal digital assistant (PDA), a wireless modem, a handheld device, a laptop computer, a cordless phone, a wireless local loop (WLL) station, or a pad, etc. With the development of wireless communication technologies, all devices that can access a communication system, can communicate with the network side of the communication system. or can communicate with other devices through the communication system are terminal devices in the examples of the present disclosure. For example, terminals and cars in intelligent transportations, household devices in smart homes, power meter reading instruments, voltage monitoring instruments and environmental monitoring instruments in smart grids, video monitoring instruments and cash registers in intelligent complete networks, etc. In the examples of the present disclosure, the terminal device may communicate with the network device, and multiple terminal devices may also communicate with each other. The terminal device may be static or mobile.

The network device 12 may be a device on an access network side and configured to support terminals to access the communication system. For example, it may be an evolved NodeB (eNB) in a 4G access technology communication system. a next generation nodeB (gNB) in a 5G access technology communication system, a transmission reception point (TRP), a relay node, an access point (AP), etc.

In a power saving project of 3GPP Release16 (R16), a power saving signal, i.e., a WUS which is also called a “wake-up signal”, is introduced for the terminal device in a connected state. The WUS is a low-power detection signal. If the terminal device detects the WUS, it means that the terminal device is expected to monitor a physical downlink control channel (PDCCH). However, if no WUS is detected, the terminal device may skip monitoring part of the PDCCH. Subsequently, in the power saving project of Release17 (R17), for an idle discontinuous reception (DRX) scenario, the power saving signal (such as a paging early indication (PEI)) is usually configured before a paging occasion (PO). It is to skip paging downlink control information (DCI) if no power saving signal is detected by the terminal device, and otherwise monitor the paging DCI. In R17, a PDCCH skipping mechanism is introduced for further enhancing the terminal device in the connected state. That is, PDCCH skipping is carried in the DCI for notifying the terminal device to skip monitoring for a period of time or to switch a search space group. As can be seen from the power saving project of R16 or R17, no matter what kind of power saving signal, a baseband chip of the terminal is required to detect the power saving signal. The term “carry” may also be described as “carry in”.

In Release18 (R18), in order to further save the power, the terminal device may add a receiver dedicated to receiving the power saving signal. FIG. 2 is a schematic structural diagram of a terminal device in an example of the present disclosure. As illustrated in FIG. 2, the terminal device 11 may include a first receiver 111, a second receiver 112, and a processor 113. The first receiver 111 is a low power wake-up receiver for receiving a wake-up signal. The second receiver 112 is a main receiver for receiving control information and/or uplink and downlink data from a network device or other terminal devices. As an example, the second receiver 112 may be a baseband chip (modem) on the terminal device. There may be one or more second receivers 112. When there are a plurality of second receivers, the frequency band of each second receiver may be identical or different.

For the terminal device illustrated in FIG. 2, how to wake up the terminal device in a connected state (RRC-Connected) through a wake-up signal is an urgent problem to be solved.

In view of this problem, an example of the present disclosure provides a communication method, which is applicable to the terminal device described in one or more of the described examples, for example, a UE. In the example of the present disclosure, the UE is in the connected state.

The communication method provided by the example of the present disclosure is described in conjunction with the UE.

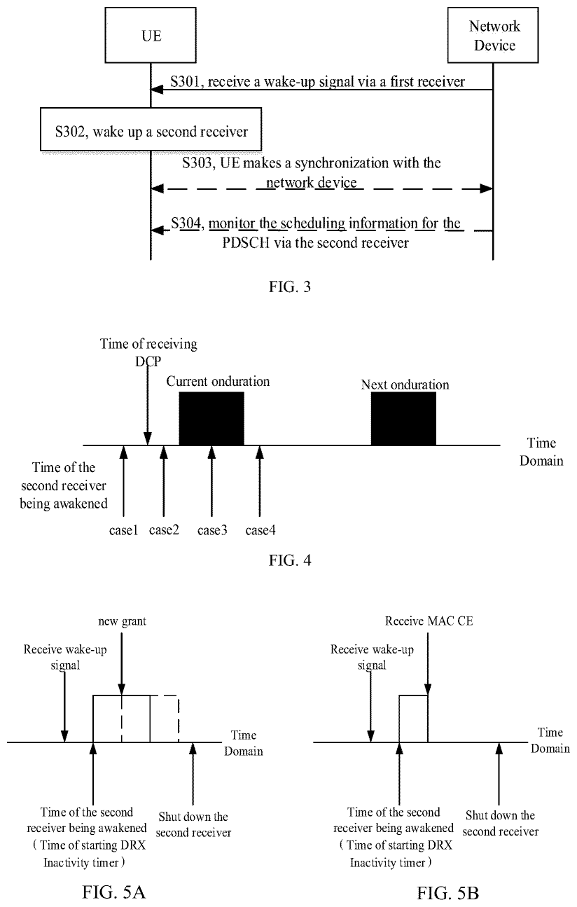

FIG. 3 is a schematic implementation flowchart of a first communication method in an example of the present disclosure. As illustrated by the solid lines in FIG. 3, the communication method may include the following steps, S301 and S302.

At S301, the UE receives a wake-up signal via a first receiver.

It is to be understood that after entering a connected state or completing a reception of uplink and downlink data, the UE may first control a second receiver to enter a sleep state, and monitor and receive the wake-up signal via the first receiver. As an example, the wake-up signal may be a low power wake-up signal, which may include an indication on traffic.

In some possible implementations, in order to further save the power, a network device may configure a first time-frequency resource for the UE, and send the wake-up signal on the first time-frequency resource. In this way, the first receiver may monitor the wake-up signal only on the first time-frequency resource.

Alternatively, or additionally, the first time-frequency resource may be configured by the network device for each UE, that is, the configuration of the first time-frequency resource is per UE. One wake-up signal may wake up one UE. Alternatively, the first time-frequency resource may be configured by the network device for each UE group, that is, the configuration of the first time-frequency resource is per group (per UE group). The same wake-up signal may wake up one group of UEs.

In practical applications, if the first time-frequency resource is configured per UE, the wake-up signal may be scrambled with a cell-radio network temporary identifier (C-RNTI). If the first time-frequency resource is configured per group, the wake-up signal may be scrambled with a UE group-RNTI (group-RNTI).

Further, in response to determining that the wake-up signal is scrambled with the group-RNTI, if the UE in the connected state enables downlink control information of power saving (DCP) to be monitored, the group-RNTI is identical with an RNTI adopted to scramble the DCP. That is, the network device may take the RNTI adopted to scramble the DCP (i.e., a powersaving-RNTI) as the group-RNTI for scrambling the wake-up signal configured for the UE group.

Furthermore, a new scrambling RNTI may be introduced to scramble the wake-up signal.

In some possible implementations, in order to enable the UE to know a frequency domain position and/or a time domain position of the first time-frequency resource carrying the wake-up signal, the network device may send an accurate or possible frequency position and/or a monitoring occasion to the UE through high-layer signaling, such as a radio resource control (RRC) signaling or a media access control-control unit (MAC CE). Alternatively, the UE may determine the accurate or possible frequency domain position and/or time domain position for monitoring the wake-up signal based on a UE-specific ID, a group ID and/or DRX parameters. It is to be understood that, the UE may determine the accurate or possible frequency position and/or the monitoring occasion of the first time-frequency resource in other ways, which is not limited by the examples of the present disclosure.

At S302, the UE wakes up the second receiver in response to the wake-up signal.

It is to be understood that after the first receiver receives the wake-up signal, the UE may wake up the second receiver. After being awakened, the second receiver may enter a DRX cycle according to the DRX parameters configured by the network device. The DRX cycle includes an active duration (active time or DRX-on) and a sleep duration (out of active time or DRX-off). During the active duration, the second receiver may monitor the scheduling information for data (hereinafter referred to as scheduling information), i.e., scheduling information for a physical downlink shared channel (PDSCH) and/or scheduling information for a physical uplink shared channel (PUSCH). For example, the scheduling information for the PDSCH and/or the scheduling information for the PUSCH may be understood as the DCP or a PDCCH.

In the example of the present disclosure, in S302 in response to determining that there are a plurality of second receivers, the UE may wake up at least one of the plurality of second receivers in response to the wake-up signal. It is to be understood that the UE may wake up part or all of the second receivers in response to the wake-up signal. As an example, assuming that the UE is a dual DRX UE (i.e., the UE includes two second receivers configured with a DRX function), after the first receiver receives the wake-up signal, the UE may wake up one of the second receivers or wake up both second receivers at the same time.

In some possible implementations, since the second receiver is previously in a sleep state, in order to avoid uplink and downlink desynchronization, the UE in the connected state may also make a synchronization with the network device after the second receiver is awakened. As illustrated by the dotted lines in FIG. 3, after S302, the method may further include the following steps, S303 and/or S304.

At S303, the UE make the synchronization with the network device.

It is to be understood that since the UE is in the sleep state, it is very likely that there is an uplink desynchronization or a downlink desynchronization. Thus, after the second receiver is awakened through S301 to S302, the UE is expected to make the synchronization with the network device.

In some possible implementations, the UE may receive a synchronization signal from the network device via the first receiver. In this case, the synchronization signal is the wake-up signal. It is to be understood that the first receiver is configured to receive only the wake-up signal, and thus the UE may make the synchronization with the network device using the wake-up signal. That is, the wake-up signal may be used for waking up the second receiver in S302, and also used for making the synchronization with the network device in S303.

In other possible implementations, the UE may receive the synchronization signal from the network device via the second receiver. In this case, the synchronization signal may be the wake-up signal, a synchronization signal carried in a synchronization signal/physical broadcast channel block (SSB), or a tracking reference signal/channel state information-reference signal (TRS/CSI-RS). It is to be understood that after the second receiver is awakened through S302, the second receiver may receive the synchronization signal from the network device, such as receiving the SSB or the TRS/CSI-RS in a broadcast channel, and thereby make the synchronization with the network device. Particularly, the second receiver may also receive the wake-up signal and use the wake-up signal to make the synchronization with the network device.

In some possible implementations, still as illustrated by the dotted lines in FIG. 3, there is no desynchronization between the UE and the network device, and thus the UE performs S304, instead of making the synchronization with the network device.

At S304, the UE monitors the scheduling information for the data via the second receiver.

It is to be understood that if there is no desynchronization between the UE and the network device or after the synchronization with the network device is made in S303, the UE may monitor the scheduling information, such as the DCP and the PDCCH, via the second receiver according to a configuration of the network device.

In some possible implementations, there may be different implementations of S304 according to different configurations of the C-DRX parameters of the UE.

In an example, if the UE is not configured with the C-DRX function, that is, the network device does not configure the C-DRX parameters for the UE, the UE immediately performs S304 to start monitoring the scheduling information after the second receiver is awakened through S301 to S302.

In another example, if the UE is configured with the C-DRX function, that is, the network device configures the C-DRX parameters for the UE, after the second receiver is awakened through S301 to S302, the UE is expected to perform S304 according to the configured C-DRX parameters, that is, the UE monitors the scheduling information via the second receiver according to the C-DRX parameters.

In some possible examples, the UE monitors the scheduling information via the second receiver according to the C-DRX parameters, which may include that: the UE periodically monitors the scheduling information via the second receiver according to the C-DRX parameters. In this case, the C-DRX parameters still include a DRX onduration timer.

As an example, FIG. 4 is a schematic diagram of periodically monitoring scheduling information by a UE in an example of the present disclosure. As illustrated in FIG. 4, the UE periodically monitors the scheduling information in various cases which are included but not limited to those described.

In a first case (case 1), the UE is configured with DCP, and it does not reach the time of receiving the DCP when the second receiver is awakened. Then, the UE starts monitoring the DCP via the second receiver, Alternatively, or additionally, if the DCP indicates to monitor a PDCCH during a DRX onduration, the UE may also monitor the PDCCH during the DRX onduration via the second receiver.

In a second case (case 1), the UE is not configured with the DCP, and it does not reach the time of the onduration when the second receiver is awakened. Since the network device does not send the DCP, after the second receiver is awakened, the UE waits for the arrival of the onduration, and monitors the PDCCH during the onduration via the second receiver.

In a third case (case 2), the UE is configured with the DCP, and the second receiver is awakened after receiving the DCP, that is, the UE misses the time of receiving the DCP. Then, the UE may directly start monitoring the PDCCH during the current onduration via the second receiver. The current onduration may be understood as a duration corresponding to the current onduration timer, that is, an upcoming onduration.

In a fourth case, it is found that the onduration timer is not started when the second receiver is awakened. The onduration timer may not be saved when the second receiver is shut down last time, that is, the onduration timer is not started in the current DRX cycle. Then, in this case, the UE may monitor the PDCCH during the next onduration via the second receiver. Under this case, the second receiver is still periodically monitoring the PDCCH.

In a fifth case (case 3), the onduration timer has not timed out when the second receiver is awakened, that is, the second receiver is awakened in the middle of the onduration, and then the UE may monitor the PDCCH during the current onduration via the second receiver. The current onduration may be understood as the duration corresponding to the current onduration timer, that is, the current onduration in which the UE is located.

In a sixth case (case 4), the onduration timer has timed out when the second receiver is awakened, and then the UE may monitor the PDCCH during the next onduration via the second receiver.

It is to be understood that the UE may periodically monitor the PDCCH via the second receiver in other cases, which is not limited by the examples of the present disclosure.

In another possible implementation, the UE monitors the scheduling information via the second receiver according to the C-DRX parameters, which may include that: the UE aperiodically monitors the scheduling information via the second receiver according to the C-DRX parameters. Alternatively, or additionally, the onduration timer is not configured for the UE configured with the C-DRX function, that is, the onduration timer is invalid. In this case, the onduration timer may not be included in the C-DRX parameters.

Furthermore, the C-DRX parameters do not include short DRX cycle parameters (for example drxShortCycleTimer, shortDRXcycle, etc.) and/or long DRX cycle parameters (for example drx-LongCycleStartOffset, longDRXcycle, drx-SlotOffset, etc.).

As an example, FIGS. 5A and 5B are schematic diagrams of aperiodically monitoring by a UE in an example of the present disclosure. As illustrated in FIGS. 5A and 5B, the UE aperiodically monitors the scheduling information, which may include: starting a DRX inactivity timer when the second receiver is awakened, and monitoring the PDCCH via the second receiver during a duration of the DRX inactivity timer.

It is to be understood that, as illustrated by the solid lines in FIG. 5A, since the onduration timer is invalid, the second receiver may start the DRX inactivity timer immediately after being awakened, enter a DRX inactivity duration (i.e., the duration of the DRX inactivity timer), and monitor the PDCCH during the DRX inactivity duration. In this way, it achieves that the UE aperiodically monitors the scheduling information via the second receiver. It is to be understood that, since the onduration timer is invalid, the UE no longer monitors the PDCCH periodically, but performs the monitoring when new data arrives (i.e., the DRX inactivity timer is started). Furthermore, the activity duration in the DRX cycle does not include the onduration.

In some possible implementations, as illustrated by the dotted line in FIG. 5A, in response to the invalidity of the onduration timer, the UE may receive an uplink grant (UL grant) or a downlink grant (DL grant), i.e., a new grant, from the network device via the second receiver. In response to the new grant, the UE extends the duration of the DRX inactivity timer. As an example, the UE may extend the duration of the DRX inactivity timer by restarting the DRX inactivity timer.

It may be understood that when expected to send uplink data to the network device (such as sending a scheduling request (SR) or a random access (RA) request), the UE may also start the DRX inactivity timer and enter the activity duration.

In some possible implementations, still as illustrated by the solid lines in (a) of FIG. 5, when the DRX inactivity timer times out, monitoring the PDCCH via the second receiver may be stopped by the UE. It may be understood that, due to the invalidity of the onduration timer, when the DRX inactivity timer times out, the UE is no longer to enter a long cycle or a short cycle, but directly enter the DRX sleep state (DRX off). In this case, monitoring the PDCCH via the second receiver is stopped by the UE.

In some possible implementations, still as illustrated in FIG. 5B, before the DRX inactivity timer times out, when the UE receives a MAC CE from the network device, monitoring the PDCCH via the second receiver may be stopped by the UE. It may be understood that, due to the invalidity of the onduration timer, when the UE receives the MAC CE from the network device, the UE is no longer to enter a long cycle or a short cycle, but enter DRX off. In this case, monitoring the PDCCH via the second receiver is stopped by the UE.

In some possible implementations, when the DRX inactivity timer times out, the UE shuts down the second receiver.

In some possible implementations, when the UE receives the MAC CE from the network device, the UE shuts down the second receiver.

In practical applications, the UE may shut down the second receiver if no UL grant or DL grant is received for a period (a preset duration) after monitoring the PDCCH via the second receiver is stopped, so as to save the power. On the contrary, once receiving the UL grant or the DL grant within the period (i.e., the preset duration) after monitoring the PDCCH via the second receiver is stopped, the UE restarts the DRX inactivity timer and returns to the step of monitoring the PDCCH via the second receiver during the duration of the DRX inactivity timer. That is, in this case, it is not to shut down the second receiver immediately, but continue the monitoring and consider the subsequent monitoring situation before performing the shutting down operation.

In the examples of the present disclosure, for the UE in the connected state, the second receiver is awakened after the wake-up signal is received via the first receiver, so as to wake up the UE in the connected state, thereby saving an energy consumption of the UE.

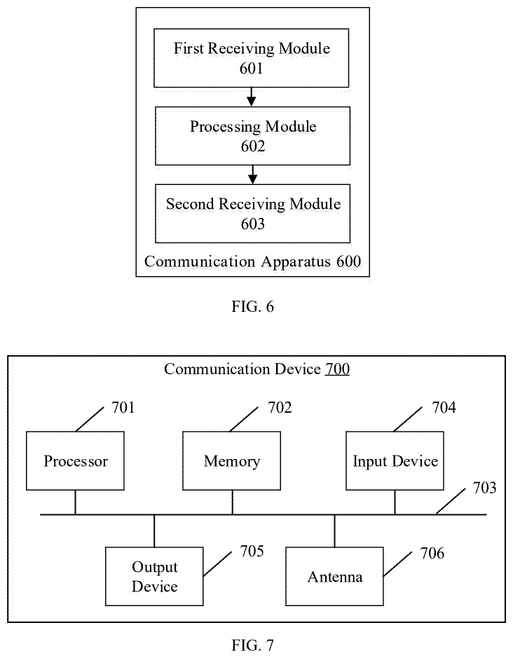

Based on the same inventive concept, the examples of the present disclosure provide a communication apparatus. The communication apparatus may be a terminal device in a connected state in a communication system or a chip or a system on chip in the terminal device. The communication apparatus may also be functional modules in the terminal device for implementing the methods described in the examples. The communication apparatus may implement the functions performed by the terminal device in the examples. These functions may be implemented through corresponding software executed by hardware. The hardware or software includes one or more modules corresponding to the functions. FIG. 6 is a schematic structural diagram of a communication apparatus 600 in an example of the present disclosure. As illustrated in FIG. 6, a communication apparatus 600 may include: a first receiving module 601 that is configured to receive a wake-up signal; and a processing module 602 that is configured to wake up a second receiving module in response to the wake-up signal.

In some possible implementations, the first receiving module 601 is configured to monitor the wake-up signal before the first receiving module 601 receives the wake-up signal.

In some possible implementations, the first receiving module 601 is configured to monitor the wake-up signal on a first time-frequency resource. The first time-frequency resource is configured per terminal device by a network device, or the first time-frequency resource is configured per terminal device group by the network device.

In some possible implementations, the wake-up signal is scrambled with a C-RNTI in response to determining that the first time-frequency resource is configured per terminal device by the network device; or the wake-up signal is scrambled with a group-RNTI in response to determining that the first time-frequency resource is configured per terminal device group by the network device.

In some possible implementations, there are a plurality of second receiving modules 603. The processing module 602 is configured to wake up at least one of the plurality of second receiving modules 603 in response to the wake-up signal.

In some possible implementations, the communication apparatus 600 further includes the second receiving module 603. The processing module 602 is configured to make a synchronization with the network device after waking up the second receiving module 603, or the second receiving module 603 is configured to monitor scheduling information for a PDSCH and/or scheduling information for a PUSCH.

In some possible implementations, the first receiving module 601 is configured to receive a synchronization signal from the network device, where the synchronization signal is the wake-up signal; and the processing module 602 is configured to make the synchronization with the network device in accordance with the synchronization signal. Alternatively, the second receiving module 603 is configured to receive the synchronization signal from the network device, where the synchronization signal is the wake-up signal, an SSB or a tracking reference signal; and the processing module 602 is configured to make the synchronization with the network device in accordance with the synchronization signal.

In some possible implementations, the processing module 602 is configured to determine that no C-DRX parameters are configured by the network device, and the second receiving module 603 is configured to monitor the scheduling information for the PDSCH and/or the scheduling information for the PUSCH.

In some possible implementations, the second receiving module 603 is configured to periodically monitor the scheduling information for the PDSCH and/or the scheduling information for the PUSCH via the second receiving module 603 according to the C-DRX parameters configured by the network device.

In some possible implementations, the second receiving module 603 is configured to monitor the DCP in a case that the DCP is configured; or monitor a PDCCH during a DRX onduration in a case that the DCP is not configured; or monitor the PDCCH during a current DRX onduration in a case that the second receiving module is awakened after the time of receiving the DCP; or monitor the PDCCH during a next DRX onduration in a case that a DRX onduration timer is not started when the second receiving module is awakened; or monitor the PDCCH during the current DRX onduration in a case that the DRX onduration timer has not timed out when the second receiving module is awakened; or monitor the PDCCH during the next DRX onduration in a case that the DRX onduration timer has timed out when the second receiving module is awakened.

In some possible implementations, the second receiving module 603 is configured to aperiodically monitor the scheduling information for the PDSCH and/or the scheduling information for the PUSCH according to the C-DRX parameters configured by the network device.

In some possible implementations, in response to determining that the second receiving module 603 aperiodically monitors the scheduling information for the PDSCH and/or the scheduling information for the PUSCH, no DRX onduration timer is configured.

In some possible implementations, the C-DRX parameters exclude at least one of the following: a DRX onduration timer, short DRX cycle parameters, or long DRX cycle parameters.

In some possible implementations, the processing module 602 is configured to start a DRX inactivity timer when the second receiving module 603 is awakened; and the second receiving module 603 is configured to monitor the PDCCH during a duration of the DRX inactivity timer.

In some possible implementations, the second receiving module 603 is configured to receive an uplink grant or a downlink grant from the network device; and the processing module 602 is configured to extend the duration of the DRX inactivity timer in response to the uplink grant or the downlink grant.

In some possible implementations, the processing module 602 is configured to start the DRX inactivity timer.

In some possible implementations, the processing module 602 is configured to stop the second receiving module 603 from monitoring the PDCCH when the DRX inactivity timer times out; or stop the second receiving module 603 from monitoring the PDCCH when the second receiving module 603 receives an MAC CE from the network device.

In some possible implementations, the processing module 602 is configured to shut down the second receiving module 603 when the DRX inactivity timer times out; or shut down the second receiving module 603 when the second receiving module 603 receives the MAC CE from the network device.

It is to be noted that the specific implementation processes of the first receiving module 601, the processing module 602 and the second receiving module 603 may refer to the detailed description of the examples illustrated in FIG. 2 to FIG. 5B, which is not repeated here for the sake of brevity of the specification.

The first receiving module 601 and the second receiving module 603 mentioned in the example of the present disclosure may be a receiving interface, a receiving circuit or a receiver, etc. The processing module 602 may be one or more processors.

Based on the same inventive concept, the examples of the present disclosure provide a communication device, which may be the terminal device described in one or more of the examples. FIG. 7 is a schematic structural diagram of a communication device in an example of the present disclosure. As illustrated in FIG. 7, a communication device 700 adopts general computer hardware, including a processor 701, a memory 702, a bus 703, an input device 704, an output device 705, and an antenna 706.

In some possible implementations, the memory 702 may include computer storage media in the form of a volatile memory and/or a nonvolatile memory, such as a read-only memory and/or a random access memory. The memory 702 may store an operating system, application programs, other program modules, executable codes, program data, user data, and the like.

The input device 704, such as a keyboard or a pointing device like a mouse, a trackball, a touch pad, a microphone, a control stick, a game pad, a satellite TV antenna, a scanner or a similar device, may be configured to enter commands and information into the communication device. These input devices may be connected to the processor 701 via the bus 703.

The output device 705 may be configured to output information of the communication device. Besides a monitor, the output device 705 may be another peripheral output device, such as a speaker and/or a printing device. These output devices may also be connected to the processor 701 through the bus 703.

The communication device 700 may be connected to a network, such as a local area network (LAN), via the antenna 706. In a networked environment, the computer-executable instructions stored in the communication device may be stored in a remote storage device, rather than being limited to the local storage.

When the processor 701 in the communication device executes the executable codes or the application programs stored in the memory 702, the communication device performs the communication method on the terminal device side or the network device side in the examples. The specific execution process refers to the examples and will not be repeated here.

In addition, the memory 702 stores computer-executable instructions for implementing the functions of the first receiving module 601, the processing module 602, and the second receiving module 603 in FIG. 6. All the functions/implementation processes of the first receiving module 601, the processing module 602 and the second receiving module 603 in FIG. 6 may be implemented by the processor 701 in FIG. 7 through calling the computer executable instructions stored in the memory 702. The specific implementation processes and functions refer to the related examples.

Based on the same inventive concept, an example of the present disclosure provides a terminal device, which is consistent with the terminal device in one or more of the examples. Alternatively, or additionally, the terminal device may be a mobile phone, a computer, a digital broadcasting terminal, a messaging device, a game console, a tablet device, a medical device, a fitness device, a personal digital assistant, and the like.

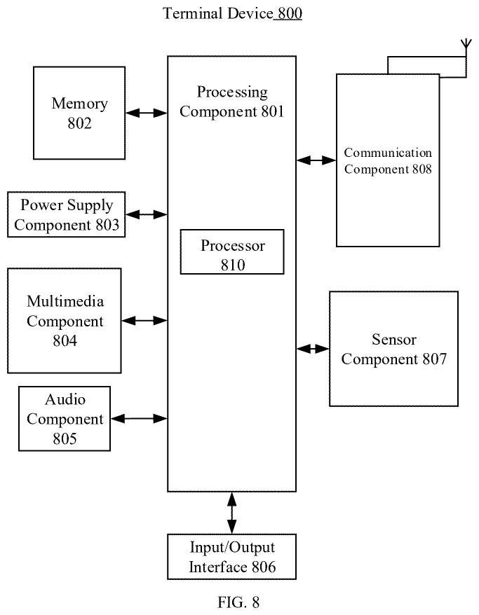

FIG. 8 is a schematic structural diagram of a terminal device in an example of the present disclosure. As illustrated in FIG. 8, the terminal device 800 may include at least one of the following components: a processing component 801, a memory 802, a power supply component 803, a multimedia component 804, an audio component 805, an input/output (I/O) interface 806, a sensor component 807, and a communication component 808.

The processing component 801 generally controls the overall operations of the terminal device 800, such as operations associated with display, phone calls, data communications, camera operations, and recording operations. The processing component 801 may include one or more processors 810 to execute instructions to complete all or a part of the steps of the methods. In addition, the processing component 801 may include one or more modules which facilitate the interaction between the processing component 801 and other components. As an example, the processing component 801 may include a multimedia module to facilitate the interaction between the multimedia component 804 and the processing component 801.

The memory 802 is configured to store various types of data to support the operations of the terminal device 800. Examples of such data include instructions for any application or method operated on the terminal device 800, contact data, phonebook data, messages, pictures, videos, and the like. The memory 802 may be implemented by any type of volatile or non-volatile storage device or combination thereof, such as static random access memory (SRAM), electrically erasable programmable read only memory (EEPROM), erasable Programmable Read Only Memory (EPROM), Programmable Read Only Memory (PROM), Read Only Memory (ROM), Magnetic Memory, Flash Memory, Magnetic or Optical Disk.

The power supply component 803 provides power for various components of the terminal device 800. The power supply component 803 may include a power management system, one or more power supplies, and other components associated with generating, managing, and distributing power for the terminal device 800.

The multimedia component 804 includes a screen providing an output interface between the terminal device 800 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some embodiments, the multimedia component 804 includes a front-facing camera and/or a rear-facing camera. The front camera and/or rear camera may receive external multimedia data when the terminal device 800 is in an operating mode, such as a photographing mode or a video mode. Each of the front and rear cameras can be a fixed optical lens system or have focal length and optical zoom capability.

The audio component 805 is configured to output and/or input audio signals. For example, the audio component 805 includes a microphone (MIC) that is configured to receive an external audio signal when the terminal device 800 is in an operating mode, such as a call mode, a recording mode, and a voice recognition mode. The received audio signal may be further stored in the memory 802 or transmitted via the communication component 808. In some examples, the audio component 805 also includes a speaker for outputting audio signals.

The I/O interface 806 provides an interface between the processing component 801 and a peripheral interface module (not shown). The peripheral interface module may be a keyboard, a click wheel, buttons, or the like. These buttons may include but not limited to a home button, a volume button, a start button and a lock button.

The sensor component 807 includes one or more sensors to provide the terminal device 800 with status assessments in various aspects. For example, the sensor component 807 may detect an open/closed state of the terminal device 800 and a relative positioning of components such as the display and keypad of the terminal device 800, and the sensor component 807 may also detect a change in position of the terminal device 800 or a component of the terminal device 800, the presence or absence of the target object contacting with the terminal device 800, orientation or acceleration/deceleration of the terminal device 800, and temperature change of the terminal device 800. The sensor component 807 may include a proximity sensor configured to detect the presence of nearby objects in the absence of any physical contact. The sensor component 807 may further include an optical sensor, such as a complementary metal-oxide-semiconductor (CMOS) or charged coupled device (CCD) image sensor which is used in imaging applications. In some examples, the sensor component 807 may also include an acceleration sensor, a gyro sensor, a magnetic sensor, a pressure sensor, or a temperature sensor.

The communication component 808 is configured to facilitate wired or wireless communication between the terminal device 800 and other devices. The terminal device 800 may access a wireless network based on a communication standard, such as WiFi, 2G, 3G, 4G, 5G, 6G or a combination thereof. In an example, the communication component 808 receives broadcast signals or broadcast related information from an external broadcast management system via a broadcast channel. In an example, the communication component 808 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the terminal device 800 may be implemented by one or more application specific integrated circuits (ASIC), digital signal processors (DSP), digital signal processing equipment (DSPD), programmable logic devices (PLD), field programmable gate array (FPGA), controller, microcontroller, microprocessor, or other electronics to perform the foregoing methods.

Based on the same inventive concept, the examples of the present disclosure also provide a non-transitory computer-readable storage medium, in which instructions are stored. The instructions, when executed on a computer, are configured to perform the communication methods on the terminal device side in one or more of the examples.

Based on the same inventive concept, the examples of the present disclosure also provide a computer program or a computer program product. The computer program product, when executed on a computer, enables the computer to implement the communication methods on the terminal device side in one or more of the examples.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the true scope and spirit of the present disclosure are set forth in the appended claims.

It should be understood that the present disclosure is not limited to the described accurate structures illustrated in the drawings, and various modifications and changes can be made to the present disclosure without departing from the scope thereof. The scope of the present disclosure is to be limited only by the appended claims.

1. A communication method, performed by a terminal device in a connected state, wherein the terminal device comprises a first receiver and a second receiver, the communication method comprising:
receiving a wake-up signal via the first receiver; and
waking up the second receiver in response to the wake-up signal.

2. The method according to claim 1, wherein before receiving the wake-up signal via the first receiver, the method further comprises:
monitoring the wake-up signal via the first receiver.

3. The method according to claim 2, wherein monitoring the wake-up signal via the first receiver comprises:
monitoring the wake-up signal on a first time-frequency resource,
wherein the first time-frequency resource is configured per terminal device by a network device, or the first time-frequency resource is configured per terminal device group by the network device.

4. The method according to claim 3, wherein
the wake-up signal is scrambled with a cell-radio network temporary identifier (C-RNTI), and the first time-frequency resource is configured per terminal device by the network device; or
the wake-up signal is scrambled with a terminal device group-radio network temporary identifier (group-RNTI), and the first time-frequency resource is configured per terminal device group by the network device.

5. The method according to claim 1, wherein there are a plurality of second receivers, wherein waking up the second receiver in response to the wake-up signal comprises:
waking up at least one of the plurality of second receivers in response to the wake-up signal.

6. The method according to claim 1, wherein after waking up the second receiver in response to the wake-up signal, the method further comprises:
making a synchronization with a network device; or
monitoring at least one of scheduling information for a physical downlink shared channel (PDSCH) or scheduling information for a physical uplink shared channel (PUSCH) via the second receiver.

7. The method according to claim 6, wherein making the synchronization with the network device comprises:
receiving a synchronization signal from the network device via the first receiver, wherein the synchronization signal is the wake-up signal; or
receiving the synchronization signal from the network device via the second receiver, wherein the synchronization signal is one of the wake-up signal, a synchronization signal block (SSB) or a tracking reference signal.

8. The method according to claim 6, wherein monitoring at least one of the scheduling information for the PDSCH or the scheduling information for the PUSCH via the second receiver comprises:
determining that no connected discontinuous reception (C-DRX) parameters are configured by the network device; and
monitoring at least one of the scheduling information for the PDSCH or the scheduling information for the PUSCH via the second receiver.

9. The method according to claim 6, wherein monitoring at least one of the scheduling information for the PDSCH or the scheduling information for the PUSCH via the second receiver comprises:
periodically monitoring at least one of the scheduling information for the PDSCH or the scheduling information for the PUSCH via the second receiver according to connected discontinuous reception (C-DRX) parameters configured by the network device.

10. The method according to claim 9, wherein periodically monitoring at least one of the scheduling information for the PDSCH or the scheduling information for the PUSCH via the second receiver comprises:
monitoring, in a case that the second receiver is configured with downlink control information of power saving (DCP), the DCP via the second receiver; or
monitoring, in a case that the second receiver is not configured with the DCP, a physical downlink control channel (PDCCH) via the second receiver during a discontinuous reception (DRX) onduration; or
monitoring, in a case that the second receiver is awakened after time of receiving the DCP, the PDCCH via the second receiver during a current DRX onduration; or
monitoring, in a case that a DRX onduration timer is not started when the second receiver is awakened, the PDCCH via the second receiver during a next DRX onduration; or
monitoring, in a case that the DRX onduration timer has not timed out when the second receiver is awakened, the PDCCH via the second receiver during the current DRX onduration; or
monitoring, in a case that the DRX onduration timer has timed out when the second receiver is awakened, the PDCCH via the second receiver during the next DRX onduration.

11. The method according to claim 6, wherein monitoring at least one of the scheduling information for the PDSCH or the scheduling information for the PUSCH via the second receiver comprises:
aperiodically monitoring at least one of the scheduling information for the PDSCH or the scheduling information for the PUSCH via the second receiver according to connected discontinuous reception (C-DRX) parameters configured by the network device.

12. The method according to claim 11, wherein in response to aperiodically monitoring at least one of the scheduling information for the PDSCH or the scheduling information for the PUSCH via the second receiver, no discontinuous reception (DRX) onduration timer is configured.

13. The method according to claim 11, wherein the C-DRX parameters exclude at least one of the following: a discontinuous reception (DRX) onduration timer, short DRX cycle parameters, or long DRX cycle parameters.

14. The method according to claim 11, wherein aperiodically monitoring at least one of the scheduling information for the PDSCH or the scheduling information for the PUSCH via the second receiver comprises:
starting a discontinuous reception (DRX) inactivity timer when the second receiver is awakened; and
monitoring a physical downlink control channel (PDCCH) via the second receiver during a duration of the DRX inactivity timer.

15. The method according to claim 11, further comprising:
receiving an uplink grant or a downlink grant from the network device; and
extending a duration of a discontinuous reception (DRX) inactivity timer in response to the uplink grant or the downlink grant.

16. The method according to claim 15, wherein extending the duration of the DRX inactivity timer comprises: starting the DRX inactivity timer.

17. The method according to claim 11, further comprising:
stopping monitoring a physical downlink control channel (PDCCH) via the second receiver when a discontinuous reception (DRX) inactivity timer times out; or
stopping monitoring the PDCCH via the second receiver when a media access control-control unit (MAC CE) is received from the network device.

18. The method according to claim 11, further comprising:
shutting down the second receiver when a discontinuous reception (DRX) inactivity timer times out; or
shutting down the second receiver when a media access control-control unit (MAC CE) is received from the network device.

19-36. (canceled)

37. A communication device, comprising:
an antenna;
a memory; and
a processor, communicatively connected respectively to the antenna and the memory, and configured to execute computer executable instructions stored in the memory to control transmission and reception of the antenna and to:
receive a wake-up signal via a first receiver; and
wake up a second receiver in response to the wake-up signal.

38, A non-transitory computer-readable storage medium, configured to store computer executable instructions thereon, wherein the computer executable instructions, after executed by a processor, implement the communication method according to claim 1.
